(19) United States
(12) Patent Application Publication
(10) Pub. No.: US 2016/0297487 A1
(43) Pub. Date: Oct. 13, 2016

(54) Boltless Track Shoe

(71) Applicant: Caterpillar Inc., Peoria, IL (US)

(72) Inventors: Tim Thorson, Morton, IL (US); Greg J. Kaufmann, Metamora, IL (US); Mark S. Diekevers, Germantown Hills, IL (US); David G. Kaminski, Spring Lake, MI (US); David Hakes, Brimfield, IL (US)

(73) Assignee: CATERPILLAR INC., Peoria, IL (US)

(21) Appl. No.: 14/685,284

(22) Filed: Apr. 13, 2015

(51) Int. Cl. B62D 55/32; B62D 55/20; B62D 55/26

(52) U.S. Cl. CPC B62D 55/32; B62D 55/26; B62D 55/20

(57) ABSTRACT

A method for connecting a track shoe to a link is disclosed. The method may include joining the track shoe and the link using friction welding. A method for constructing a track assembly is also disclosed. The method may include utilizing friction welding to attach a plurality of links to a plurality of track shoes. A track assembly is also disclosed. The track assembly may include a link and a track shoe attached to the link via friction welding.

### FIELD OF THE DISCLOSURE

The present disclosure relates generally to tracked undercarriages and, more particularly, to systems and methods for joining track shoes and links.

### BACKGROUND OF THE DISCLOSURE

Many mobile machines have tracked undercarriages that move along the ground as the machine travels. Examples of mobile machines with tracked undercarriages may include, but not be limited to, excavators, tractors, dozers, and the like. Generally, tracked undercarriages include an endless or continuous track driven by two or more wheels. A weight of the machine may be better distributed by the large surface area of the tracks, enabling a continuous tracked machine to traverse soft ground with less likelihood of becoming stuck due to sinking. In addition to low ground pressure, continuous tracks may provide added traction and increased durability.

Typically, a continuous track of an undercarriage is made of modular steel plates called track shoes. A link assembly serves as the flexible backbone of the continuous track. The link assembly generally includes a plurality of links assembled into laterally spaced pairs. Each pair of links is attached to a track shoe with nuts and bolts. More specifically, each link includes holes for receiving bolts, as well as seats for receiving nuts to secure the bolts. To secure the track shoe to each link, the track shoe is placed against the link, and bolts are inserted through holes in the track shoe and the holes in the link. Nuts are then secured on the bolts against the seats of the link.

Over time, the nuts and bolts can loosen, which may cause the track shoes to fall off. In addition, attaching the track shoes to the links using bolts involves a time-consuming, complex assembly procedure. Furthermore, additional features and tight tolerances are required for the bolted joint, which adds cost to the undercarriage assembly. Accordingly, there is a need to provide a robust alternative attachment method for track shoes and links.

A method of repairing a worn track link is disclosed in International Patent Application Publication No. WO 00/29276, entitled, “Method of Repairing a Worn Track Link.” The 00/29276 publication describes a method including the step of providing a solid bearing element having a bearing surface. The method further includes the step of welding the bearing element to the track link to cover the bearing surface of the track link. While effective, improvements are desired in the construction and repair of track assemblies.

### SUMMARY OF THE DISCLOSURE

In accordance with one embodiment, a method for connecting a track shoe to a link is disclosed. The method may include joining the track shoe and the link using friction welding.

In accordance with another embodiment, a method for constructing a track assembly is disclosed. The method may include utilizing friction welding to attach a plurality of links to a plurality of track shoes.

In accordance with another embodiment, a track assembly is disclosed. The track assembly may include a link and a track shoe attached to the link via friction welding.

These and other aspects and features will become more readily apparent upon reading the following detailed description when taken in conjunction with the accompanying drawings. In addition, although various features are disclosed in relation to specific exemplary embodiments, it is understood that the various features may be combined with each other, or used alone, with any of the various exemplary embodiments without departing from the scope of the disclosure.

### BRIEF DESCRIPTION OF THE DRAWINGS

FIG. 1 is a diagrammatic view of a machine, in accordance with one embodiment of the present disclosure;

FIG. 2 is a side view of a track assembly for the machine of FIG. 1;

FIG. 3 is a perspective view of the track assembly of FIG. 2;

FIG. 4 is a perspective view of part of a link assembly for the track assembly of FIG. 3;

FIG. 5 is a cross-sectional view of a welded joint between a track shoe and a link via electric resistance welding (ERW) or friction welding, in accordance with an embodiment of the present disclosure;

FIG. 6 is a flowchart illustrating an example process for connecting a track shoe to a link via ERW, in accordance with an embodiment of the present disclosure;

FIG. 7 is a perspective view of a link with protrusions for ERW, in accordance with an embodiment of the present disclosure;

FIG. 8 is a perspective view of a track shoe with protrusions for ERW, in accordance with an embodiment of the present disclosure;

FIG. 9 is a perspective view of a link with a monolithic protrusion for ERW, in accordance with an embodiment of the present disclosure;

FIG. 10 is a side view of a temporary joint with electrodes connected to a track shoe and a link for ERW, in accordance with an embodiment of the present disclosure;

FIG. 11 is a diagrammatic view of applied pressure to the temporary joint of FIG. 10;

FIG. 12 is a diagrammatic view of a circuit including a power supply connected to the temporary joint of FIG. 10;

FIG. 13 is a flowchart illustrating an example process for connecting a track shoe to a link via friction welding, in accordance with an embodiment of the present disclosure;

FIG. 14 is a side view of a track shoe and a link during friction welding, in accordance with an embodiment of the present disclosure;

FIG. 15 is a side view of a weld of a track shoe and a link after friction welding, in accordance with an embodiment of the present disclosure;

FIG. 16 is a flowchart illustrating an example process for constructing a track assembly, in accordance with an embodiment of the present disclosure;

FIG. 17 is a flowchart illustrating another example process for constructing a track assembly, in accordance with an embodiment of the present disclosure; and

FIG. 18 is a perspective view of part of a link assembly, in accordance with an embodiment of the present disclosure.

While the present disclosure is susceptible to various modifications and alternative constructions, certain illustrative embodiments thereof will be shown and described below in detail. The disclosure is not limited to the specific embodiments disclosed, but instead includes all modifications, alternative constructions, and equivalents thereof

### DETAILED DESCRIPTION

The present disclosure provides methods for connecting a track shoe to a link. One disclosed method includes joining the track shoe and the link using electric resistance welding. Another disclosed method includes joining the track shoe and the link using friction welding. In so doing, the disclosed methods provide for boltless track shoes. By eliminating the use of nuts and bolts to attach track shoes and links, the disclosed methods provide a more robust track assembly, as well as, a more efficient assembly procedure.

Reference will now be made in detail to specific embodiments or features, examples of which are illustrated in the accompanying drawings. Generally, corresponding reference numbers will be used throughout the drawings to refer to the same or corresponding parts.

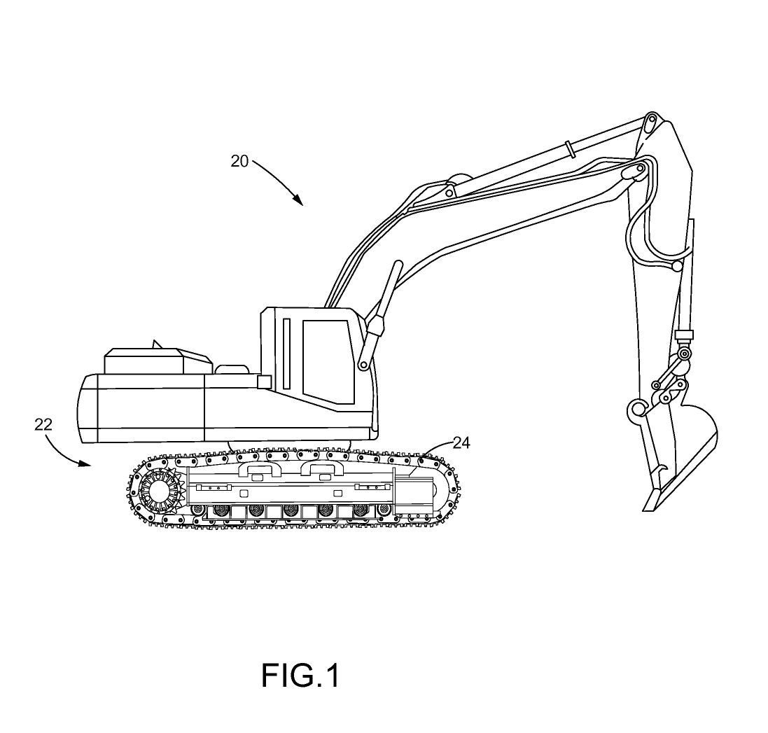

FIG. 1 illustrates a machine 20 including an undercarriage system 22 with a track assembly 24, consistent with certain embodiments of the present disclosure. It is to be understood that although the machine 20 is illustrated as an excavator, the machine 20 may be of any other type that includes a tracked undercarriage system 22. As used herein, the term “machine” refers to a mobile machine that performs a driven operation involving physical movement associated with a particular industry, such as, earthmoving, construction, landscaping, forestry, agriculture, etc.

Non-limiting examples of machines include commercial and industrial machines, such as, earth-moving vehicles, excavators, tractors, dozers, loaders, backhoes, agricultural equipment, material handling equipment, and other types of machines that operate in a work environment. It is to be understood that the machine 20 is shown primarily for illustrative purposes to assist in disclosing features of various embodiments, and that FIG. 1 does not depict all of the components of a machine.

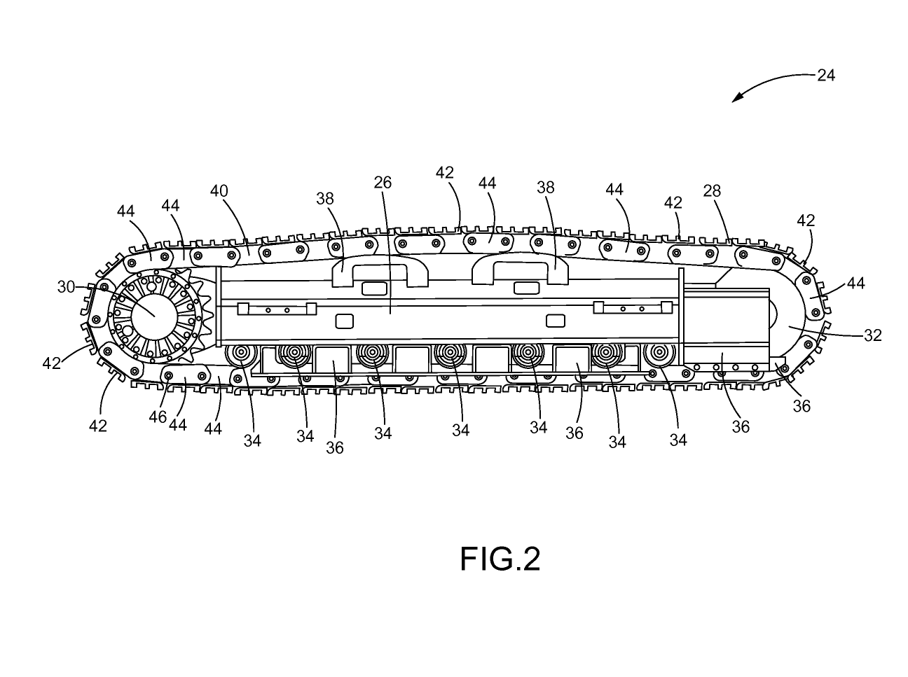

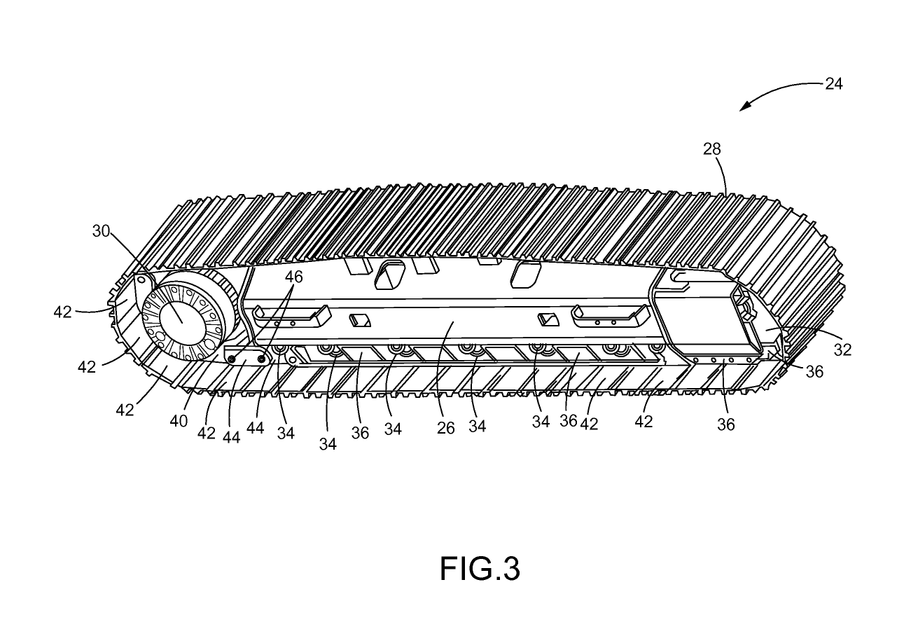

The undercarriage system 22 may be configured to support the machine 20 and move the machine 20 along the ground, road, and other types of terrain. As shown in FIGS. 2 and 3, the track assembly 24 of the undercarriage system 22 may include a track roller frame 26, various guiding components connected to the track roller frame 26, and an endless track 28 engaging the guiding components. The guiding components may guide the track 28 and include a drive sprocket 30, an idler 32, rollers 34, track guides 36, and carriers 38, although other components may be used.

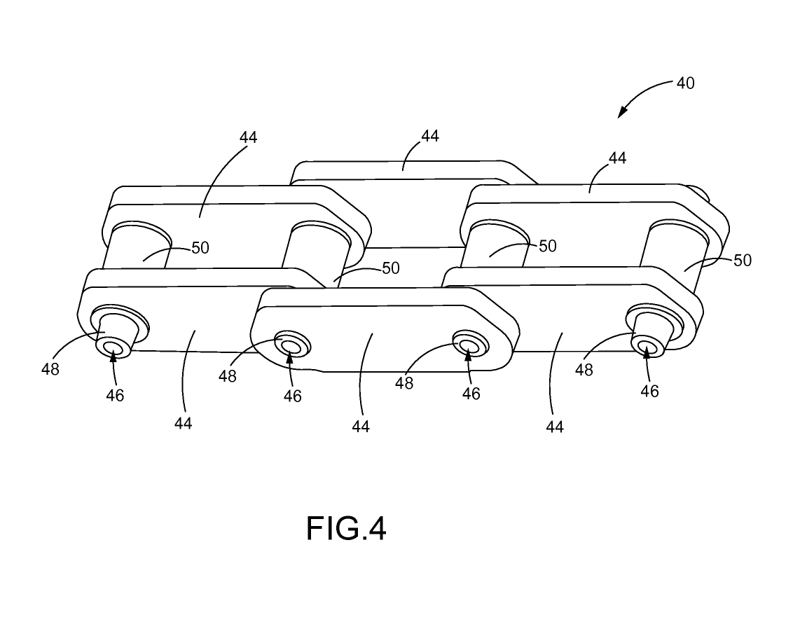

The track 28 may include a link assembly 40 with a plurality of shoes 42 secured thereto. The link assembly 40 may form a flexible backbone of the track 28, and the shoes 42 may provide traction on the various types of terrain. The link assembly 40 may extend in an endless chain around the drive sprocket 30, the rollers 34, the idler 32, and the carriers 38. More specifically, the link assembly 40 may include a plurality of links 44 connected to one another at pivot joints 46. As shown in FIG. 4, the links 44 may be arranged in laterally spaced pairs. Pins 48, installed in bushings 50, may connect the links 44 adjacent to one another at the pivot joints 46, as well as fix the links 44 in laterally spaced relationships to one another.

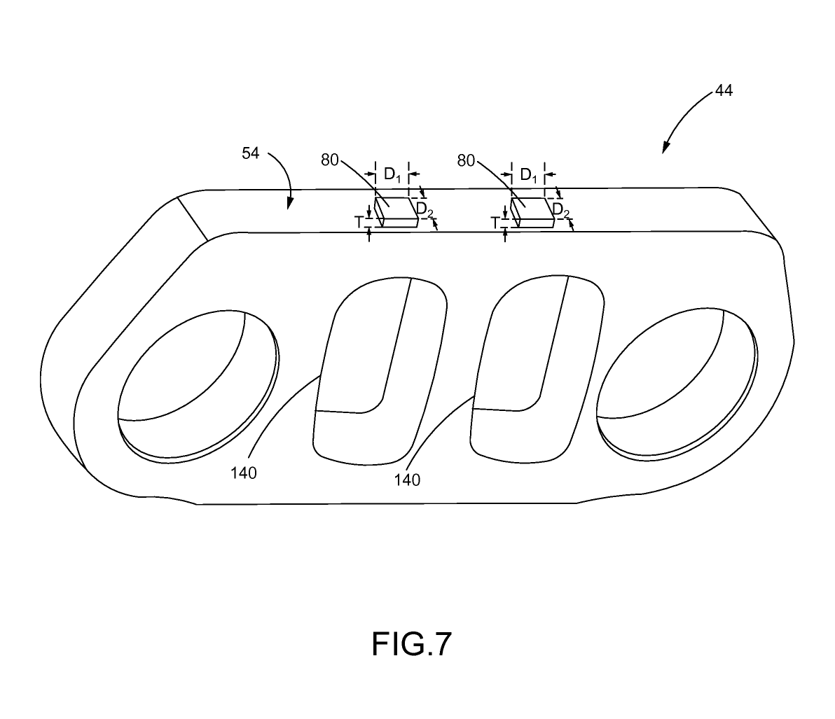

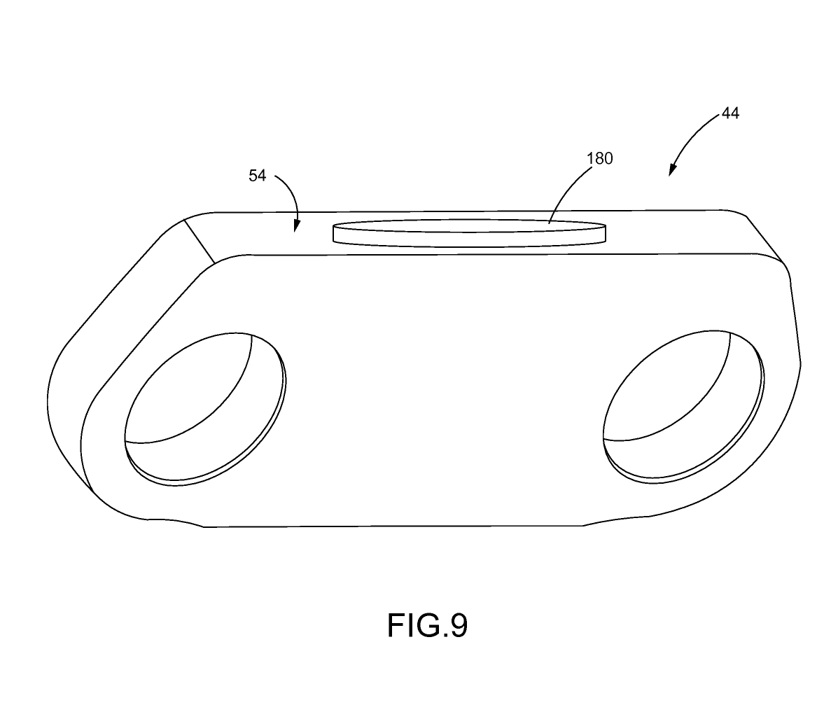

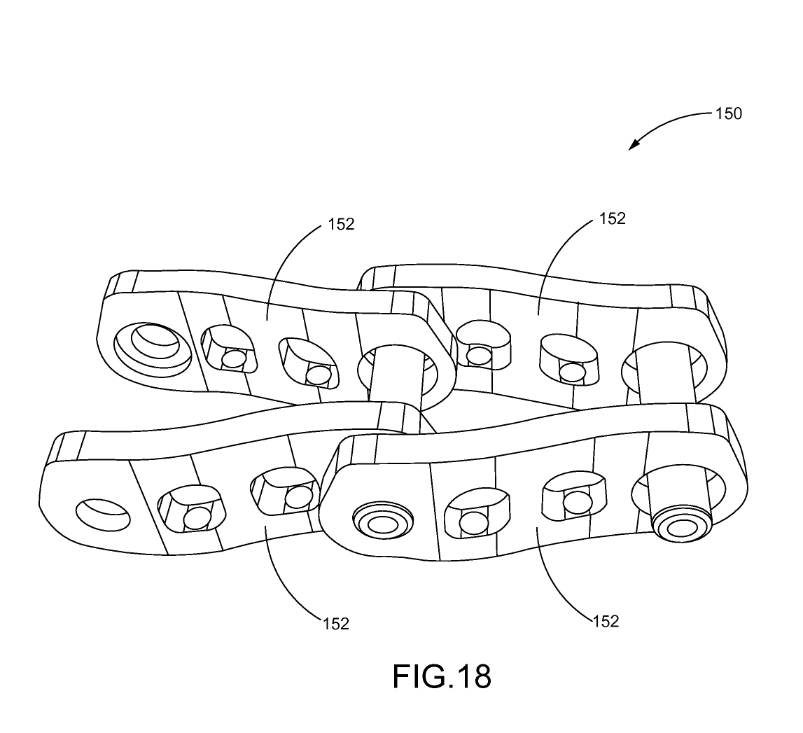

It is to be understood that other configurations for the link assembly 40 than that shown in FIG. 4 may be used. For example, the link assembly 40, in FIG. 4, depicts a straight or inline link assembly with straight links. However, in another embodiment, the link assembly 40 may be an offset link assembly 150 with offset links 152, as shown in FIG. 18. Furthermore, the links 44 of the link assembly 40 may be of any type. For instance, the link 44 may have windows 140, as shown in FIG. 7, or the link 44 may not have windows, as shown in FIG. 9.

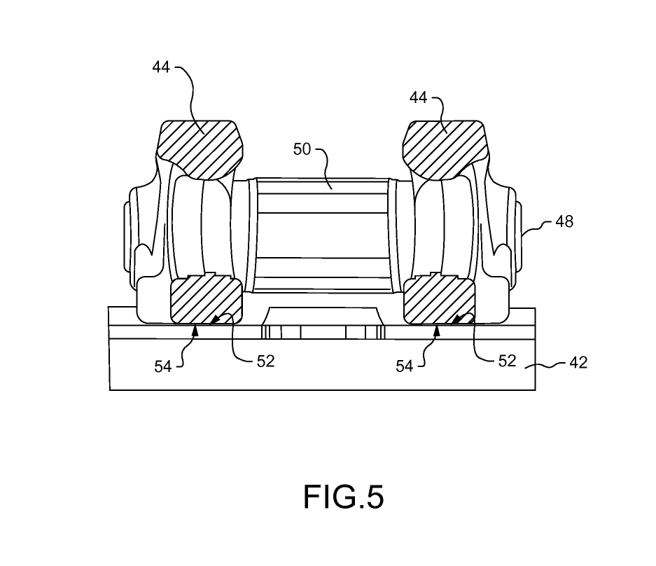

Referring back to FIGS. 2 and 3, track shoes 42 may be secured to the perimeter of link assembly 40. For example, one shoe 42 may be attached to each laterally spaced pair of links 44. The track shoes 42 may be connected to the links 44 via various welding methods. For instance, as shown in FIG. 5, a faying surface 52 of each track shoe 42 and a faying surface 54 of each link 44 may be welded together. However, other surfaces of the track shoes 42 and links 44 than that shown in FIG. 5 may be used as faying surfaces.

In one embodiment, electric resistance welding (ERW) may be used to join the track shoes 42 permanently to the links 44. In ERW, heat required to weld the faying surfaces 52, 54 of the track shoes 42 and the links 44 together may be generated by the electrical resistance of the materials used when electrical current is passed through the track shoes 42 and the links 44. For example, the track shoes 42 and the links 44 may be composed of steel, although other materials may be used. The track shoes 42 may be composed of a different grade of steel than a grade of steel of the links 44. However, the track shoes 42 and the links 44 may also be composed of the same grade of steel.

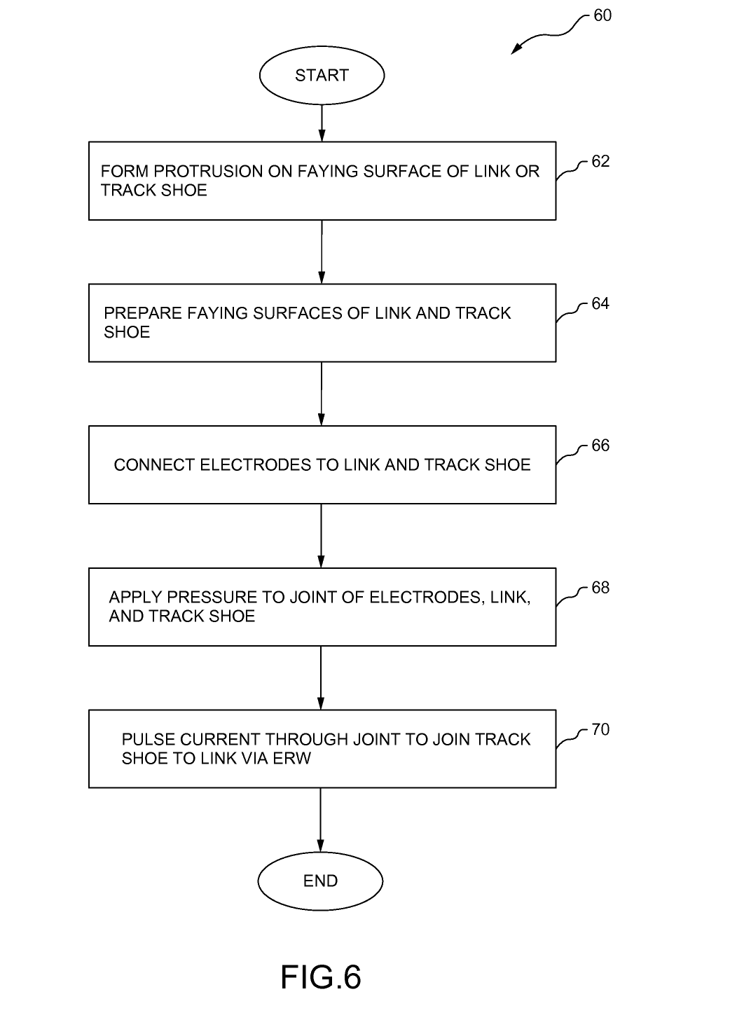

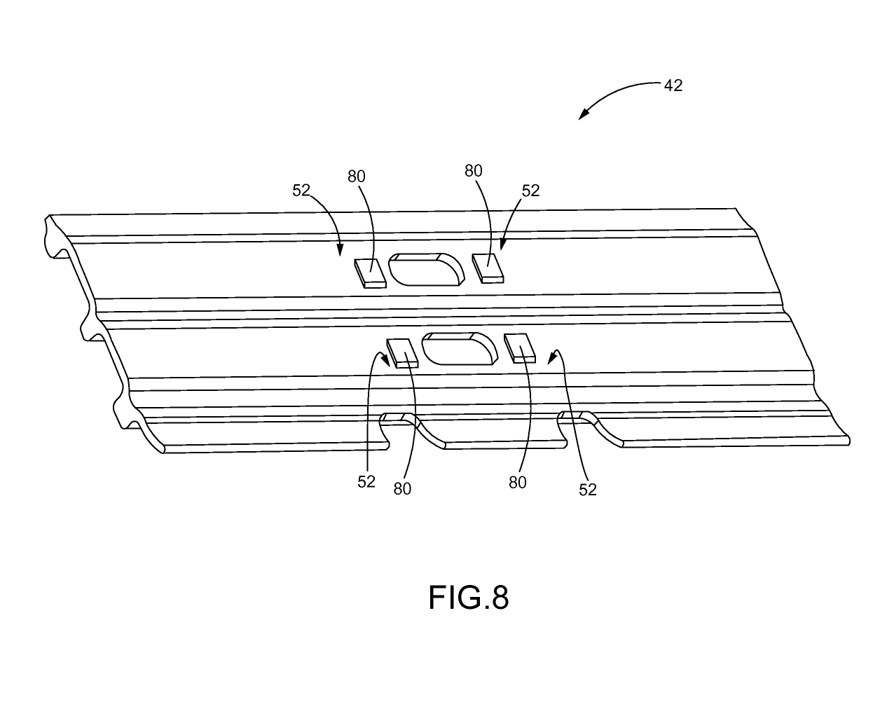

Referring now to FIG. 6, with continued reference to FIGS. 1-5, a flowchart illustrating an example process 60 for connecting a track shoe 42 to a link 44 via ERW is shown, according to an embodiment of the present disclosure. The process 60 may comprise forming at least one protrusion 80 (FIGS. 7 and 8) on the faying surface 54 of the link 44 and/or the faying surface 52 of the track shoe 42, at block 62. As shown in the examples of FIGS. 7 and 8, the protrusions 80 may extend outwardly from the link 44 and/or the track shoe 42, and may comprise a point of electrical contact between the link 44 and track shoe 42 through which current flows during ERW.

The protrusions 80 may be formed via forging, machining, laser cutting, or any other suitable process. For instance, the protrusions 80 may be rectangular in shape. However, the protrusions may also be cubic, pyramidal, cylindrical, triangular in cross-section, semi-circular in cross-section, and any other geometric shape. Although two protrusions 80 are shown in FIG. 7 and four protrusions 80 are shown in FIG. 8, any number of protrusions may be provided. For example, an array of protrusions 80 may be provided on the link 44 and/or track shoe 42. In another example, shown in FIG. 9, a forge flash may be used for a monolithic protrusion 180 that is thin and long.

Referring back to the example shown in FIG. 7, each of dimensions D₁, D₂ of the protrusions 80 may be between an inclusive range of 0.5 mm and 15 mm, although other lengths for the dimensions D₁, D₂ of the protrusions 80 may be used. Furthermore, dimension D₁ may or may not be equal to dimension D_{2.} In an example, a thickness T of the protrusions 80 may be between an inclusive range of 0.1 mm and 2 mm. However, other dimensions for the thickness T of the protrusions 80 may be used. Moreover, the dimensions D₁, D₂ and the thickness T of the protrusions 80 may depend on a size of the link 44 and/or track shoe 42, and an amount of electrical resistance desired. It is to be understood that the numerical ranges disclosed herein for the dimensions D₁, D₂ and the thickness T are for example purposes only and that various sizes may be used for the protrusions 80.

Referring back to FIG. 6, at block 64, the faying surface 54 of the link 44 and/or the faying surface 52 of the track shoe 42 may be prepared in order to facilitate electrical contact and fusion there between. For example, the faying surfaces 52, 54 may be smoothed and cleaned to remove surface contaminants or an oxidation layer on the surfaces 52, 54. Sanding, grit blasting, wire brushing, or any other suitable process may be used.

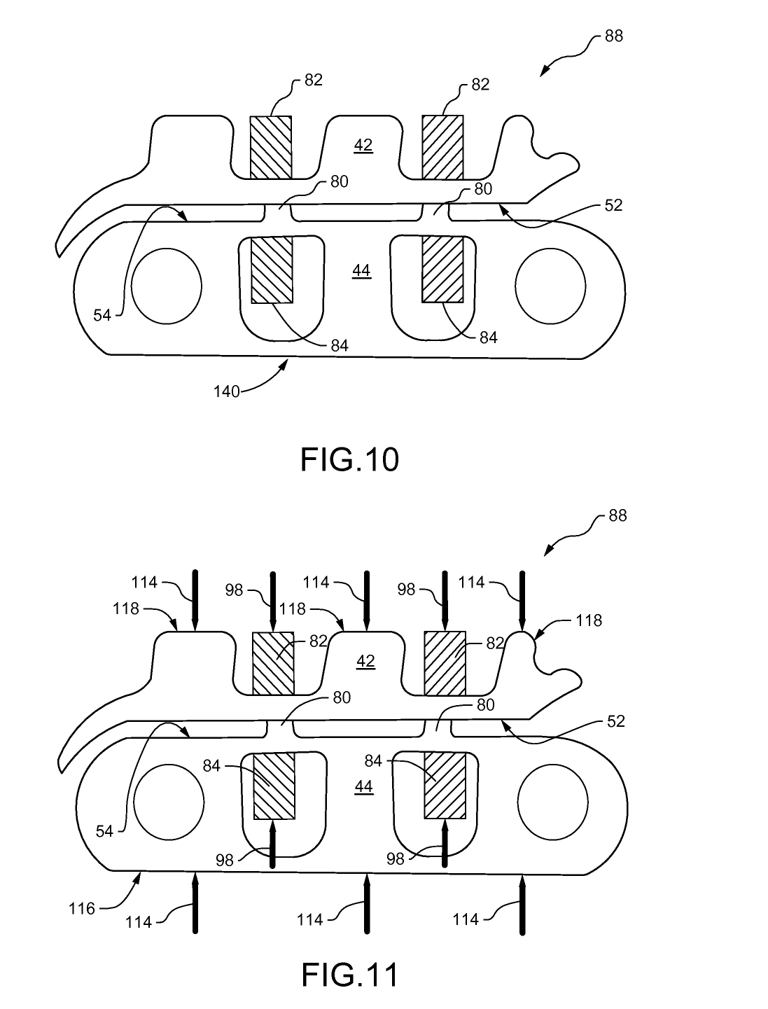

At block 66, electrodes 82, 84 (FIG. 10) may be connected to the track shoe 42 and the link 44. As shown in FIG. 10, first electrodes 82 may be provided in contact with the track shoe 42 in proximity to the faying surface 52 of the track shoe 42, and second electrodes 84 may be provided in contact with the link 44 in proximity to the faying surface 54 of the link 44. For example, the electrodes 82, 84 may be composed of copper or copper alloy. However, other electrically conductive material may be used for the electrodes 82, 84.

The first electrodes 82 may be custom shaped to interface with the track shoe 42, and the second electrodes 84 may be custom shaped to interface with the link 44. Furthermore, in an example, the first electrodes 82 and the second electrodes 84 may be aligned with a central axis of each protrusion 80. More specifically, a first electrode 82 and a second electrode 84 may be positioned on the track shoe 42 and the link 44, respectively, such that a direct electrical path is created through a protrusion 80 in the faying surface 54 of the link 44 and through the faying surface 52 of the track shoe 42 that contacts the protrusion 80.

Although two first electrodes 82 and two second electrodes 84 are shown in FIG. 10, any number of electrodes may be used. In addition, positions of the first electrodes 82 and the second electrodes 84 may be different than that shown in FIG. 10. In one example, if the link 44 does not have the windows 140, the second electrodes 84 may instead be positioned on a surface 142 of the link 44.

In addition, the protrusions 80 and electrodes 82, 84 may be sized according to an electrical resistance ratio. As used herein, the electrical resistance ratio may be defined as a ratio of a contact area of the protrusion 80 to a contact area of the first electrode 82. The contact area of the protrusion 80 may be the surface area of the protrusion 80 on the link 44 that is in contact with the faying surface 52 of the track shoe 42. The contact area of the first electrode 82 may be the surface area of the first electrode 82 that is in contact with the track shoe 42. In an example, the electrical resistance ratio may be between an inclusive range of 0.05 to 1 and 0.5 to 1. The second electrodes 84 may have the same dimensions as the first electrodes 82. However, in other embodiments, the second electrodes 84 may have different dimensions than the first electrodes 82.

At block 68, in FIG. 6, pressure may be applied to hold the first electrode 82, the track shoe 42, the link 44, and the second electrode 84 together in a temporary joint 88 (FIG. 10). More specifically, the first electrode 82, the track shoe 42, the link 44, and the second electrode 84 may be pressed together in place with the protrusion 80 on the faying surface 54 of the link 44 abutting the faying surface 52 of the track shoe 42. For example, an external force may be applied to the joints 88 via a clamp, a spring loaded mechanism, a hydraulic press, pneumatic industrial equipment, and any other suitable mechanism. The amount of force applied to the joint 88 may be between an inclusive range of 10 kN and 100 kN, although other amounts of force may be used. As shown in FIG. 11, in addition to a pressure 98 being applied to the first and second electrodes 82, 84, additional pressure 114 may be applied to the link 44 at surface 116 and/or to the track shoe 42 at surfaces 118 in order to fuse the link 144 to the track shoe 42.

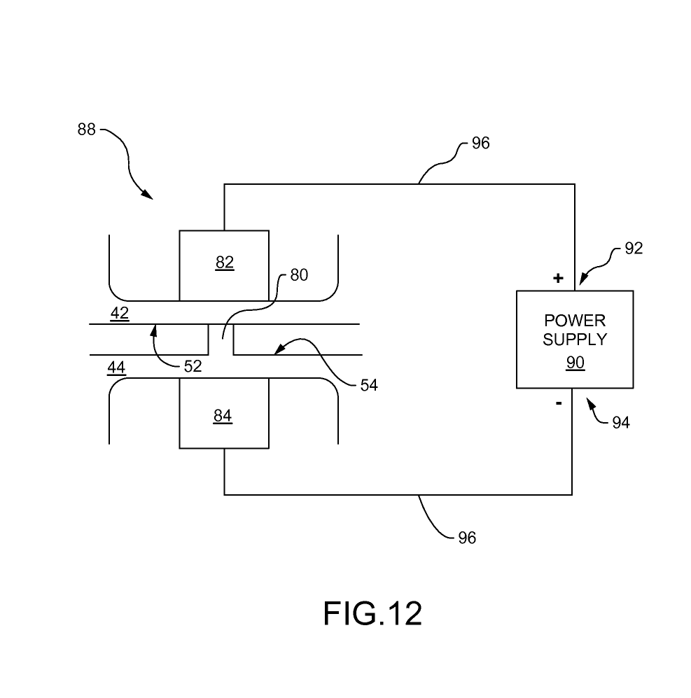

Referring back to FIG. 6, at block 70, current may be passed through the joint 88 in order to join the track shoe 42 to the link 44. For example, a power supply 90 (FIG. 12) may be used to pulse current through the first electrode 82, the track shoe 42, the link 44, and the second electrode 84. The power supply 90 may comprise a battery, a capacitor bank, a stud welding power supply, or any other suitable source of current. In one example, a positive terminal 92 of the power supply 90 may be connected to the first electrode 82, and a negative terminal 94 of the power supply 90 may be connected to the second electrode 84. However, other configurations may be used.

Furthermore, cables 96 used to connect the power supply 90 to the electrodes 82, 84 may comprise low inductance cable connections. For instance, cables 96 may be as short as possible in order to maximize the amount of current pulsed through the joint 88. In an example, the power supply 90 may be configured to apply current to the joint 88 between an inclusive range of 900 amps and 20,000 amps. In another example, the power supply 90 may be configured to apply current to the joint 88 between an inclusive range of 900 amps and 12,000 amps. However, other amounts of current may be used. The power supply 90 may also be configured to apply current for a period of time between an inclusive range of 0.05 sec and 0.6 sec, although other time periods may be used.

The amount of current and the length of time the current is supplied to join the track shoe 42 to the link 44 via ERW may depend on the physical dimensions of the track shoe 42 and the link 44. Furthermore, after the current is pulsed through the temporary joint 88, the track shoe 42 and the link 44 may be fused together in a metallurgical bond. The cables 96 may then be disconnected from the electrodes 82, 84, and the electrodes 82, 84 may be detached from the track shoe 42 and the link 44.

In another embodiment, friction welding may be used to join the track shoes 42 permanently to the links 44. In friction welding, heat required to weld the faying surfaces 52, 54 of the track shoes 42 and the links 44 together may be generated by mechanical friction between the track shoes 42 and the links 44. More specifically, frictional heat may be created between the faying surface 52 of the track shoe 42 and the faying surface 54 of the link 44, while a lateral force or upset may displace and fuse the track shoe 42 to the link 44.

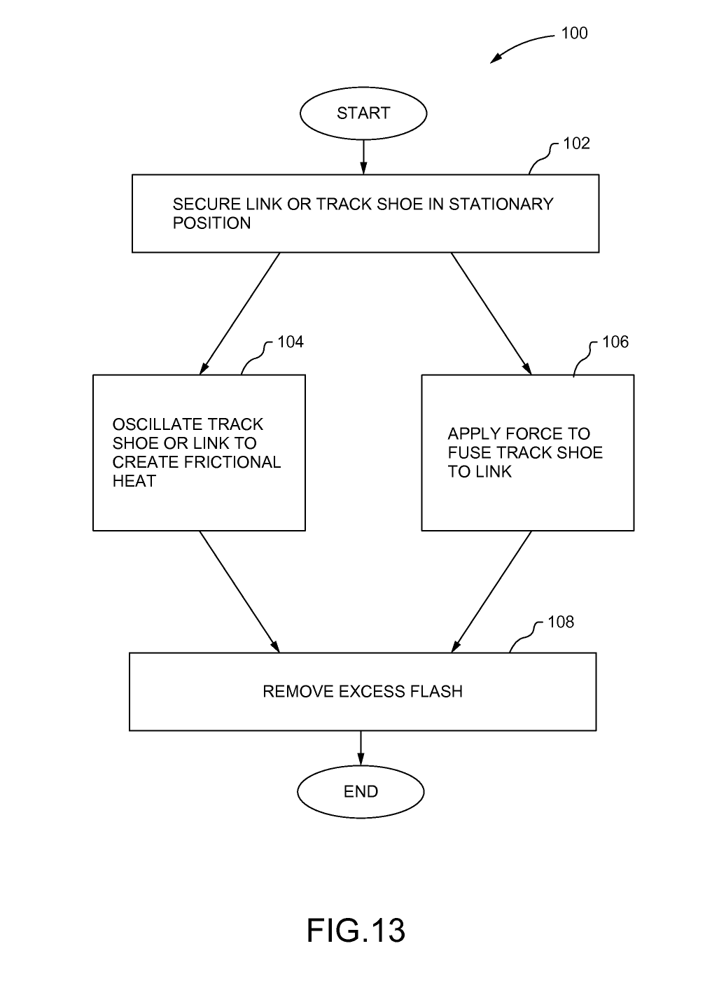

Turning now to FIG. 13, with continued reference to FIGS. 1-12, a flowchart illustrating an example process 100 for connecting a track shoe 42 to a link 44 via friction welding is shown, according to an embodiment of the present disclosure. The process 100 may comprise securing the link 44 in a stationary position, at block 102. For example, the link 44 may be secured in a custom made fixture designed to hold the specific shape of link 44. However, the link 44 may also be secured using a clamp or any other suitable mechanism.

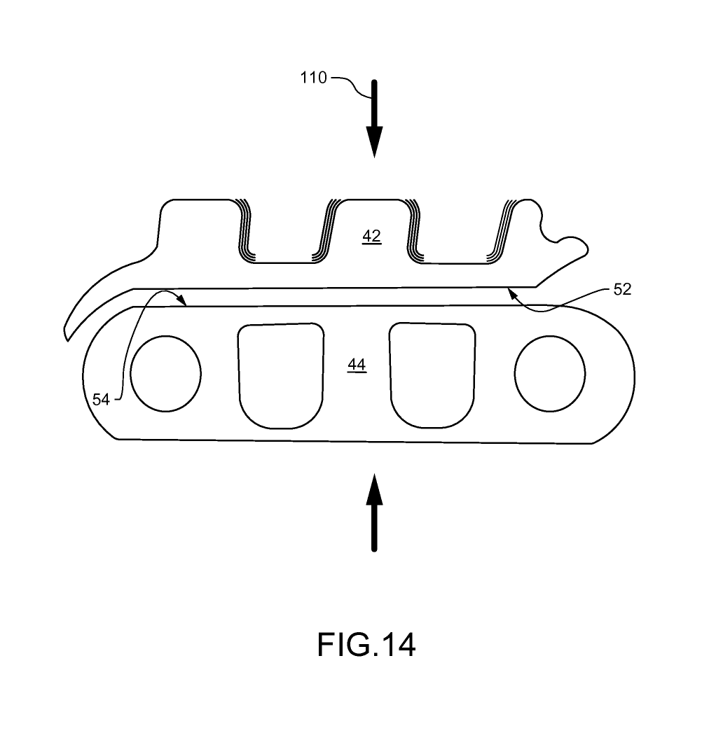

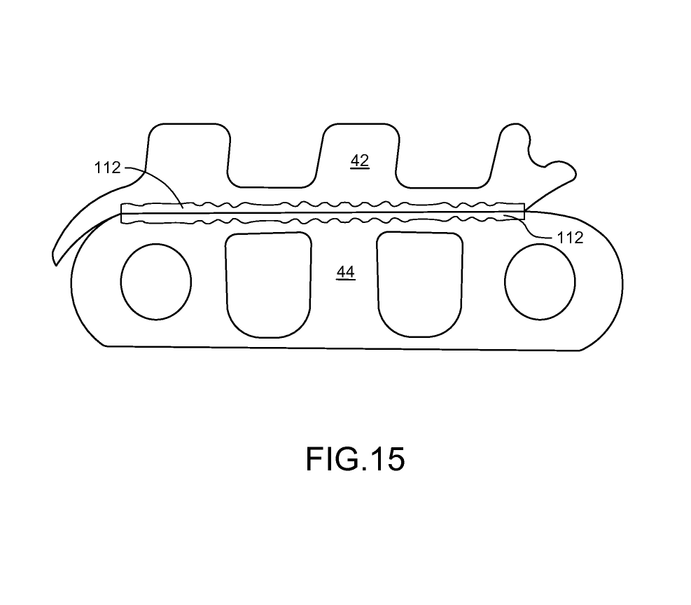

At block 104, the track shoe 42 may be vibrated or oscillated against the link 44 in order to generate frictional heat between the faying surface 52 of the track shoe 42 and the faying surface 54 of the link 44. For example, the track shoe 42 and the link 44 may be joined via linear or orbital friction welding with the track shoe 42 oscillating back and forth in a linear or orbital direction. For instance, from the view shown in FIG. 14, the track shoe 42 may be oscillated in and out of the page against the link 44. However, the track shoe 42 may also be oscillated back and forth from side to side as well, in reference to the view shown in FIG. 14.

In one example, the track shoe 42 may linearly or orbitally slide against the link 44 approximately 1 mm to 2.5 mm in each direction. An amplitude of oscillation of the track shoe 42 may be between an inclusive range of 2 mm and 5 mm. However, other lengths and amplitudes of oscillation of the track shoe 42 may be used. In addition, the track shoe 42 may be oscillated between an inclusive range of 10 Hz and 100 Hz, although other frequencies for oscillation of the track shoe 42 may be used.

At block 106, a force may be applied to displace and fuse the track shoe 42 to the link 44 while the track shoe 42 is oscillating against the link 44. The force applied to the track shoe 42 may increase as the track shoe 42 is pushed against the link 44. More specifically, while the track shoe 42 is linearly or orbitally sliding across the link 44 generating frictional heat between the faying surfaces 52, 54, an axial load 110 (FIG. 14) may be applied to press the track shoe 42 and the link 44 together, thereby fusing the track shoe 42 to the link 44. The axial load applied on the track shoe 42 and the link 44 may be between an inclusive range of 20 tons and 120 tons, although other loads may be used.

In one example, a friction welding machine or a hydraulically actuated press may be used to oscillate the track shoe 42 and apply the force to fuse the track shoe 42 to the link 44. However, other types of equipment may be used. With the friction welding machine, the amount of load to apply to the track shoe 42 and the link 44, as well as the amount of time to apply the load, may be preset and preprogrammed into a controller of the machine. The controller of the machine may include a memory and any type of processing unit used to control the friction welding process. In addition, a custom made fixture designed to hold the specific shape of the track shoe 42 may be attached to the machine.

Furthermore, it is to be understood that instead of the link 44 being secured in the stationary position and the track shoe 42 being oscillated, the track shoe 42 may be secured in the stationary position and the link 44 may be oscillated against the track shoe 42. In addition, the faying surface 52 of the track shoe 42 and the faying surface 54 of the link 44 may not have to be prepared prior to friction welding. The mechanical friction may remove contaminants and oxidation layers during the welding process. However, the faying surfaces 52, 54 may also be prepared via sanding, grit blasting, wire brushing, or any other suitable process prior to friction welding.

At block 108, an excess flash 112 (FIG. 15) may be removed from a perimeter of the weld of the track shoe 42 and the link 44 after the track shoe 42 and the link 44 are fused together in a metallurgical bond via friction welding. The excess flash 112 may be material that is forced out of the weld between the faying surfaces 52, 54 of the track shoe 42 and the link 44 when the track shoe 42 and the link 44 are pushed together during friction welding. For example, the excess flash may be laser cut, trimmed by a forge press, or removed by any other suitable process.

### INDUSTRIAL APPLICABILITY

In general, the foregoing disclosure finds utility in various industrial applications, such as, in earthmoving, construction, landscaping, forestry, and agricultural machines. In particular, the disclosed track assembly and methods may be applied to any machine with a tracked undercarriage, such as, earth-moving vehicles, excavators, tractors, dozers, loaders, backhoes, agricultural equipment, material handling equipment, and the like.

By applying the disclosed track assembly and methods to a machine, a robust welded joint between a track shoe and a link can be achieved. Both electric resistance welding (ERW) and friction welding result in a metallurgic fusion of the materials of the track shoe and the link, thereby leading to strong, durable joints between the track shoes and links. Furthermore, ERW and friction welding eliminate many of the manufacturing concerns that are present in bolted joints.

For example, to obtain a requisite clamp force in a bolted joint of a track shoe and link, manufacturers need to consider tolerances, alignment, and machining of straight surfaces for each part because the nuts and bolts only provide a mechanical connection between the track shoe and the link. However, with ERW and friction welding such concerns are insignificant due to the metallurgical bond that is created between the track shoe and the link. In so doing, a robust and efficient attachment method for track shoes and links is provided.

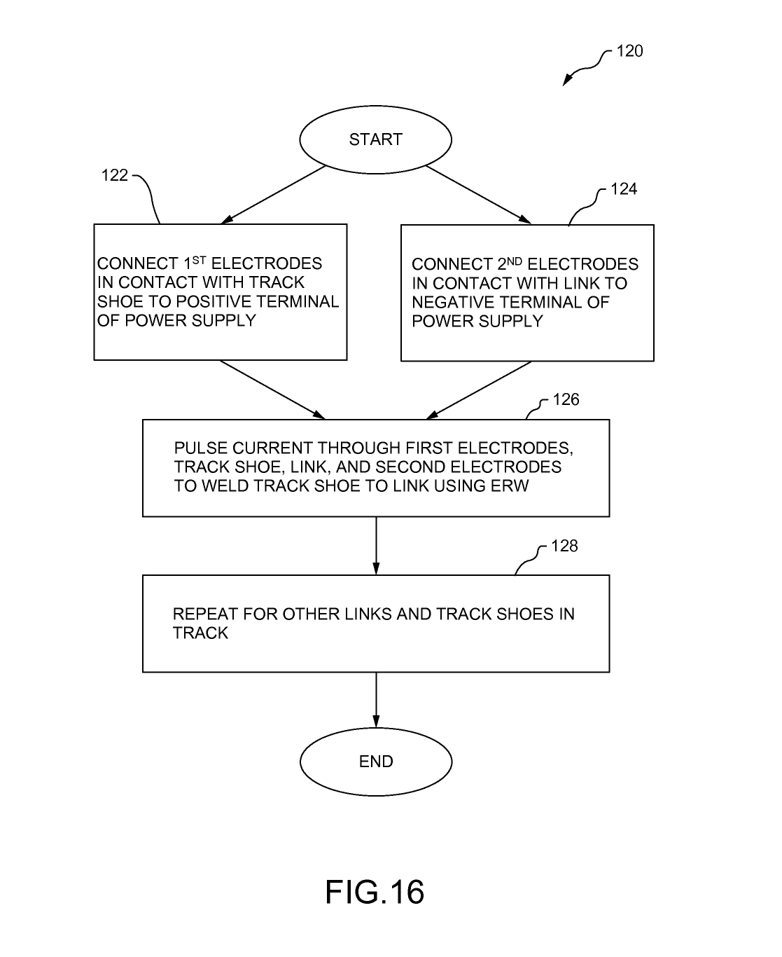

Turning now to FIG. 16, with continued reference to FIGS. 1-15, a flowchart illustrating an example process 120 for constructing a track assembly 24 is shown, according to another embodiment of the present disclosure. The process 120 may comprise utilizing ERW to attach a plurality of links 44 to a plurality of track shoes 42. For example, a first track shoe may be joined to a first link via ERW.

More specifically, at block 122, the first electrodes 82 in contact with the first track shoe may be connected to the positive terminal 92 of the power supply 90. At block 124, the second electrodes 84 in contact with the first link may be connected to the negative terminal 94 of the power supply 90. At block 126, the power supply 90 may pulse current through the first electrodes 82, the first track shoe, the first link, and the second electrodes 84 in order to produce a welded joint between the first track shoe and the first link using ERW.

At block 128, the same process may be repeated for the other links 44 and track shoes 42 needed to construct track 28 of the track assembly 24. For example, the first track shoe may then be joined via ERW to a second link that is laterally spaced from the first link in a similar manner. Subsequently, an adjacent track shoe may be joined to an adjacent laterally spaced pair of links in a similar manner, and so forth. In so doing, all of the track shoes 42 of a track 28 may be attached to all of the links 44 in order to construct the track assembly 24. It may also be possible to attach a track shoe to two links, or a laterally spaced pair of links, at a same time using ERW.

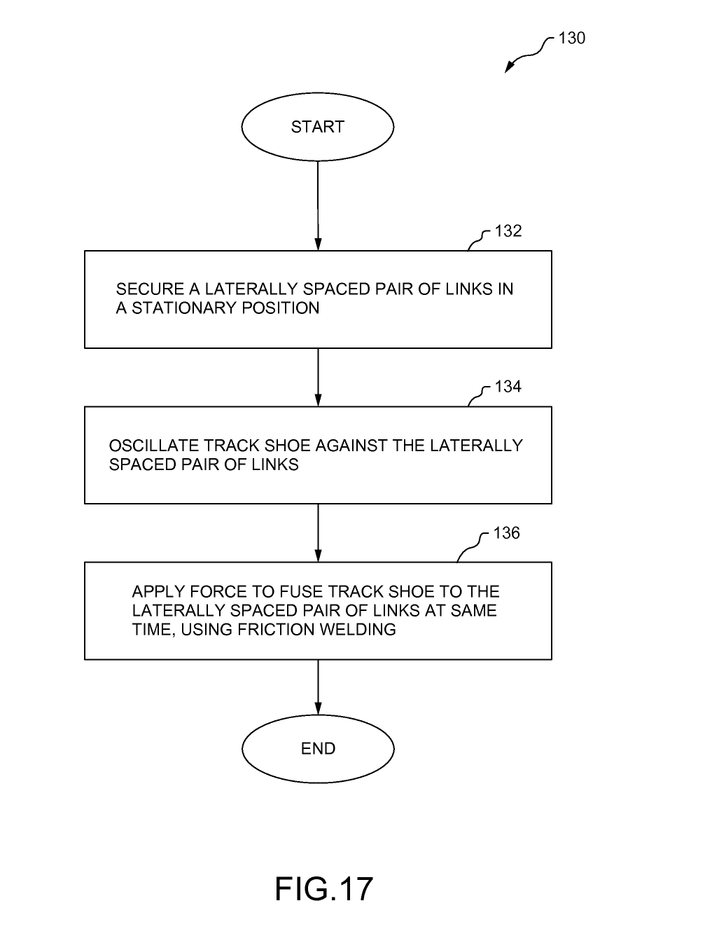

Turning now to FIG. 17, with continued reference to FIGS. 1-16, a flowchart illustrating an example process 130 for constructing a track assembly 24 is shown, according to another embodiment of the present disclosure. The process 130 may comprise utilizing friction welding to attach a plurality of links 44 to a plurality of track shoes 42. For example, a first track shoe may be joined to a first link and a second link at a same time. The first link and the second link may comprise a laterally spaced pair of links in the link assembly 40.

More specifically, a laterally spaced pair of links may be secured in a stationary position, at block 132. At block 134, a first track shoe may be oscillated against the laterally spaced pair of links at the same time. At block 136, a force may be applied to fuse the first track shoe to the laterally spaced pair of links at the same time. Subsequently, an adjacent track shoe may be joined to an adjacent laterally spaced pair of links simultaneously in a similar manner, and so forth. In so doing, all of the track shoes 42 of a track 28 may be attached to all of the links 44 in order to construct the track assembly 24. It may also be possible to attach the track shoe to the first link using friction welding, and then subsequently attach the track shoe to the second link using friction welding, instead of attaching the track shoe to the first and second links simultaneously.

It is to be understood that the flowcharts in FIGS. 6, 13, 16, and 17 are shown and described as an example only to assist in imparting features of the present disclosure, and that more or less steps than that shown may be included in the methods corresponding to the various features described above without departing from the scope of the disclosure.

While the foregoing detailed description has been given and provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims appended hereto. Moreover, while some features are described in conjunction with certain specific embodiments, these features are not limited to use with only the embodiment with which they are described, but instead may be used together with or separate from, other features disclosed in conjunction with alternate embodiments.

What is claimed is:

1. A method for connecting a track shoe to a link, the method comprising:
joining the track shoe and the link using friction welding.

2. The method of claim 1, further comprising creating frictional heat between a faying surface of the track shoe and a faying surface of the link.

3. The method of claim 2, further comprising securing the link in a stationary position.

4. The method of claim 3, further comprising oscillating the track shoe against the link.

5. The method of claim 4, further comprising using at least one of linear friction welding or orbital friction welding to join the track shoe and the link.

6. The method of claim 5, further comprising sliding the track shoe back and forth against the link approximately 1 mm to 2.5 mm in each direction.

7. The method of claim 6, further comprising oscillating the track shoe between an inclusive range of 10 Hz and 100 Hz.

8. The method of claim 4, further comprising applying a force to fuse the track shoe to the link.

9. The method of claim 8, further comprising generating an axial load between an inclusive range of 20 tons and 120 tons on the track shoe and link.

10. The method of claim 8, further comprising using a hydraulically actuated press to oscillate the track shoe and apply the force to fuse the track shoe to the link.

11. The method of claim 8, further comprising laser cutting an excess flash around a perimeter of a weld of the track shoe and the link.

12. The method of claim 2, further comprising securing the track shoe in a stationary position.

13. The method of claim 12, further comprising oscillating the link against the track shoe.

14. A method for constructing a track assembly, the method comprising:
utilizing friction welding to attach a plurality of links to a plurality of track shoes.

15. The method of claim 14, wherein the step of utilizing friction welding to attach the plurality of links to the plurality of track shoes further comprises utilizing at least one of linear friction welding or orbital friction welding to attach the plurality of links to the plurality of track shoes.

16. The method of claim 14, further comprising friction welding at least two links to a track shoe at a same time.

17. The method of claim 16, further comprising securing the at least two links in a stationary position.

18. The method of claim 17, further comprising oscillating the track shoe against the at least two links at a same time.

19. The method of claim 18, further comprising applying a force to fuse the track shoe to the at least two links at a same time.

20. A track assembly, comprising:
a link; and
a track shoe attached to the link via friction welding.
